(19) United States
(12) Patent Application Publication
(10) Pub. No.: US 2023/0122675 A1
(43) Pub. Date: Apr. 20, 2023

(54) ESTIMATION AND RANKING METHOD FOR CARBON EMISSION OF INDIVIDUAL LIFE

(71) Applicant: Yidi WANG, Tianjin (CN)

(72) Inventor: Yidi WANG, Tianjin (CN)

(21) Appl. No.: 17/607,034

(22) PCT Filed: Oct. 21, 2021
(86) PCT No.: PCT/CN2021/125197

§ 371 Date: Oct. 28, 2021

(30) Foreign Application Priority Data
Oct. 19, 2021 (CN) 202111216613.5

(51) Int. Cl. G06N 7/02; G06F 17/10

(52) U.S. Cl. CPC G06N 7/02; G06F 17/10; G06F 2219/10

(57) ABSTRACT

An estimation and ranking method for carbon emission of individual life, which includes the following steps: collecting and acquiring personal daily life clothing, food, housing, and transportation data; performing fuzzy interval processing on the collected data, and calculating carbon emissions corresponding to each behavior expressed by the fuzzy interval number according to the carbon emission coefficient of each behavior; using fuzzy interval number addition, the carbon emissions corresponding to each individual behavior are added according to different time scales to obtain the fuzzy interval value of the total carbon emissions of the individual on different time scales; use the fuzzy interval number comparison method to obtain the ranking of the carbon emissions of individuals in a specific group on the same time scale. The present invention performs effective size comparison and ranking of personal carbon emissions within a certain group range, and the analysis result is reasonable and accurate.

### BACKGROUND

### Technical Field

The invention relates to the technical field of urban energy planning and evaluation, in particular to an estimation and ranking method for carbon emission of individual life.

### Description of Related Art

Many countries in the world have proposed the goal of carbon peaking and carbon neutrality, which requires the joint efforts of governments, enterprises, organizations and individuals to achieve it. The so-called Low Carbon Living (LCL) refers to trying to reduce the energy consumed in life in order to reduce carbon dioxide emissions and contribute to ecological civilization. With the progress of the times, the concept of low-carbon life has received more and more attention and recognition from people. People want to know their daily carbon emissions. At present, there is a certain calculation basis for the carbon emissions generated by a specific behavior, such as one kilowatt-hour of electricity consumption approximately produces 0.997 kg of carbon dioxide emission, and one ton of water consumption approximately produces 0.194 kg of carbon dioxide emission, and taking an elevator up or down one floor produces approximately 0.218 kg carbon dioxide emission. However, there is still a lack of long-term effective statistical analysis and calculation methods for the actual overall situation of personal carbon emissions in daily life.

People produce carbon emissions in all aspects of food, clothing, housing and transportation, and the same behavior has different levels of carbon emissions due to the specific factors involved. For example: the carbon emissions per kilometer of driving different brands of cars are obviously different. The same is to eat steak, the carbon emissions produced by different intakes are also different. It is very difficult and unrealistic to accurately calculate the carbon emissions of all the carbon emissions involved in daily activities. Therefore, considering the uncertainty of people's daily life behaviors, it's crucial to present a method for reasonable estimating of the carbon emission data generated in personal life and effective ranking within a certain group with the help of fuzzy interval theory and methods. It will guide people to analyze personal carbon emission behavior, and help to develop a low-carbon and environmentally friendly living habit.

### SUMMARY

The purpose of the present invention is to design an effective method for estimation and ranking of personal life carbon emissions within a certain group, the analysis results of which are reasonable and accurate, and have good practicability, adaptability and scalability.

This invention provides an estimation and ranking method for carbon emission of individual life, including the following steps:

An estimation and ranking method for carbon emission of individual life, the steps are as follows:

1) Collecting and acquiring personal daily life food, clothing, housing and transportation data;

2) Fuzzy interval processing is performed on the collected food, clothing, housing and transportation data, and the carbon emission corresponding to each behavior expressed by the fuzzy interval number is calculated according to the carbon emission coefficient of each behavior;

3) Adopting fuzzy interval number addition rule, add the carbon emissions corresponding to each individual behavior to obtain the fuzzy interval value of the total carbon emissions of the individual on different time scales, then use the same method to obtain the fuzzy interval value of total carbon emissions of each person in the specific group on different time scales;

4) Sum the fuzzy interval values of the total carbon emissions of each person in a specific group on the same time scale, and divide by the total number of people in the specific group to obtain the per capita fuzzy carbon emission value, and then obtain the benchmark interval number. Then using the fuzzy interval number comparison method, the ranking of the carbon emissions of individuals in a specific group on the same time scale is obtained.

Further, the fuzzy interval processing method for the collected food, clothing, housing and transportation data is: processing the food, clothing, housing and transportation data x to obtain a triangular fuzzy number \tilde{B}=(x,α,β), where (x,α,β)means that the value of the data x is in the interval [x−α, x+β].

Further, the ranking method of fuzzy interval number is:

Getting the reference interval number \hat{X}₀=[x, x̅], and the midpoint of the interval is) Mid(\hat{X}₀)=(x̅+x)/2, the radius of the interval r0=(x̅−x)/2, then for the multiple fuzzy interval values (i=1, 2, . . . , m) to be compared for a specific group, obtaining the midpoint of the intervals Mid(\hat{X}ᵢ) and the radius ri=Rad(\hat{X}ᵢ) and obtaining di=Mid(\hat{X}₀)−Mid(\hat{X}ᵢ), and using the following formula to obtain a credibility measure ρ(dᵢ) for which the fuzzy interval value of individual carbon emission to be compared is less than the reference interval number, wherein the greater the credibility measure, the less the individual's carbon emission:

$$ρ ( {d}_{i} ) = \{ \begin{matrix}\frac{{d}_{i} + {r}_{0} + {r}_{i}}{{r}_{0}} & {d}_{i} < - ( {r}_{0} + {r}_{i} ) \\ \frac{1}{2} {( \frac{{d}_{i} + {r}_{0} + {r}_{i}}{{r}_{0} + {r}_{i}} )}^{2} & - ( {r}_{0} + {r}_{i} ) \leq {d}_{i} < 0 \\ 0.5 & {d}_{i} = 0 \\ 1 - \frac{1}{2} {( \frac{{r}_{0} + {r}_{i} - {d}_{i}}{{r}_{0} + {r}_{i}} )}^{2} & 0 < {d}_{i} \leq {r}_{0} + {r}_{i} \\ \frac{{d}_{i}}{{r}_{0}} & {d}_{i} > {r}_{0} + {r}_{i}\end{matrix} .$$

Further, the personal daily life of the individual's daily life includes: occurrence period, behavioral type, specific behavior, duration, and quantity.

The advantages and positive effects of this invention are:

This invention uses the fuzzy interval calculation method to reasonably estimate the carbon emission data generated in the individual's daily life under uncertainty, and uses the fuzzy interval size comparison method to effectively compare and rank the personal life carbon emissions within a certain group, and the analysis results are reasonable and accurate. The method has good practicability, adaptability and generalizability.

### BRIEF DESCRIPTION OF THE DRAWINGS

FIG. 1 is the flow chart of the estimation and ranking method for personal life carbon emission of this invention;

FIG. 2 is a schematic diagram of a triangular fuzzy number in an embodiment of this invention.

### DESCRIPTION OF THE EMBODIMENTS

In order to make the objectives, technical solutions, and advantages of the implementation of this invention clearer, the technical solutions in the implementation of this invention will be described in more detail below in conjunction with the accompanying descriptive figures. In the figures, the same or similar reference numerals indicate the same or similar elements or elements with the same or similar functions. The described embodiments are part of the embodiments of this invention, rather than all of the embodiments. The embodiments described below with reference to the accompanying figures are exemplary, and are intended to explain this invention, but should not be construed as limiting this invention. Based on the embodiments of this invention, all other embodiments obtained by those of ordinary skill in the art without creative work shall fall within the protection scope of this invention.

The embodiments of this invention will be described in detail below with reference to the accompanying descriptive figures.

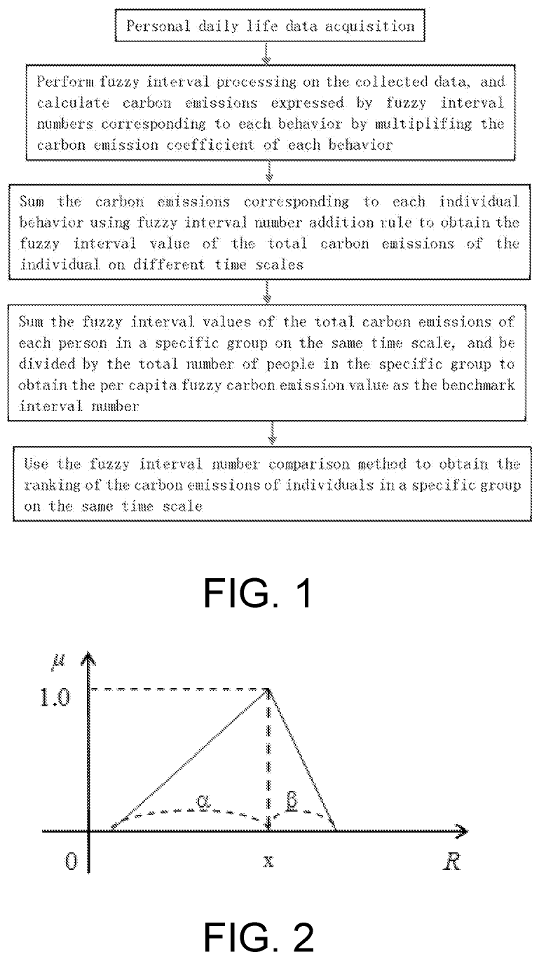

The estimation and ranking method of personal life carbon emission of this invention, as shown in FIG. 1, includes the following steps:

1) Collect and acquire personal daily life data on food, clothing, housing and transportation, which include occurrence period, behavioral type, specific behavior, duration, and quantity.

2) Fuzzy interval processing is performed on the collected food, clothing, housing, and transportation data, and the fuzzy interval processing method is: processing the food, clothing, housing and transportation data x to obtain a triangular fuzzy number \tilde{B}=(x,α,β) where(x,α,β) refers to the value of the data x is distributed in the interval [x−α,x+β] with different degree of membership.

3) Using fuzzy interval addition, add the carbon emissions corresponding to each individual behavior to obtain the fuzzy interval value of the total carbon emissions of the individual on different time scales, then use the same method to obtain the fuzzy interval value of total carbon emissions of each person in the specific group on different time scales.

4) Sum the fuzzy interval values of the total carbon emissions of each person in a specific group on the same time scale, and divide by the total number of people in the specific group to obtain the per capita fuzzy carbon emission value of the specific group, and then obtain the benchmark interval number; Using the fuzzy interval comparison method, the ranking of the carbon emissions of individuals in a specific group on the same time scale is obtained.

Specifically, the fuzzy interval comparison method is:

Get the reference interval number \hat{X}₀=[x, x̅], and the midpoint of the interval is Mid(\hat{X}₀)=(x̅+x)/2, the radius of the interval r0=(x̅−x)/2. Then for the multiple fuzzy interval values (i=1, 2, . . . , m) to be compared for a specific group, obtain the midpoint of the intervals Mid(\hat{X}ᵢ) and the radius ri=Rad(\hat{X}ᵢ), and obtain di=Mid(\hat{X}₀)−Mid(\hat{X}ᵢ), and use the following formula to obtain a credibility measure ρ(dᵢ) for which the fuzzy interval value of individual carbon emission to be compared is less than the reference interval number. The greater the credibility measure, the less the individual's carbon emission:

$$ρ ( {d}_{i} ) = \{ \begin{matrix}\frac{{d}_{i} + {r}_{0} + {r}_{i}}{{r}_{0}} & {d}_{i} < - ( {r}_{0} + {r}_{i} ) \\ \frac{1}{2} {( \frac{{d}_{i} + {r}_{0} + {r}_{i}}{{r}_{0} + {r}_{i}} )}^{2} & - ( {r}_{0} + {r}_{i} ) \leq {d}_{i} < 0 \\ 0.5 & {d}_{i} = 0 \\ 1 - \frac{1}{2} {( \frac{{r}_{0} + {r}_{i} - {d}_{i}}{{r}_{0} + {r}_{i}} )}^{2} & 0 < {d}_{i} \leq {r}_{0} + {r}_{i} \\ \frac{{d}_{i}}{{r}_{0}} & {d}_{i} > {r}_{0} + {r}_{i}\end{matrix} ,$$

It should be noted that the carbon emission coefficient (unit carbon emission) corresponding to each behavior of personal clothing, food, housing, transportation is known, as shown in Table 1:

TABLE 1
personal carbon emission coefficient (unit carbon
emission) corresponding to each behavior of personal
clothing, food, housing, transportation

| | | Carbon emission | |
|---|---|---|---|
| | | coefficient (unit | |
| | | carbon emission) | |
| | Living behavior | (kg/unit) | |
| clothing | Buy clothes | 4 | kg/piece |
| | Use washing machine | 0.399 | kg/h |
| | . . . | . . . | |
| food | Eat meat | 1.24 | kg/kg |
| | Eat vegetables | 0.138 | kg/kg |
| | Eat rice | 0.8 | kg/kg |
| | . . . | . . . | |
| housing | Use electricity | 0.997 | kg/kWh |
| | Use water | 0.194 | kg/ton |
| | Use natural gas | 2.17 | kg/m³ |
| | Use coalgas | 0.72 | kg/m³ |
| | Use coal | 2.493 | kg/kg |
| | Turn on energy-saving lamps | 0.011 | kg/h |
| | Turn on the tungsten bulb | 0.041 | kg/h |
| | Turn on air conditioner | 0.621 | kg/h |
| | Turn on electric fan | 0.045 | kg/h |
| | Use refrigerator | 0.997 | kg/d |
| | Watch TV | 0.096 | kg/h |
| | Use laptop | 0.013 | kg/h |
| | Use desktop computer | 0.332 | kg/h |
| | Take a hot bath | 0.42 | kg/time |
| | Dispose of garbage | 2.06 | kg/kg |
| | . . . | . . . | |
| transportation | Drive car | 0.22 | kg/km |
| | Take train | 0.01 | kg/km |
| | Take bus | 0.08 | kg/km |
| | Take plane | 0.275 | kg/km |
| | Take the tube | 0.04 | kg/km |
| | Take the elevator up and down | 0.218 | kg/floor |

| | |
|---|---|
| . . . | . . . |

Specifically, in this embodiment, calculation and analysis are carried out by taking the estimation of a person's life carbon emissions and the ranking of the community in which they live as an example, and the details are as follows:

1. Data acquisition. Collect the personal daily life data on food, clothing, housing and transportation of one person in one day, as shown in Table 2.

TABLE 2
personal daily life data being collected of one person in one day

| Time | |
|---|---|
| interval | Living behavior |
| 6-7 | wash face and teeth with about 0.1 L of water; energy- |
| | saving lamps are turned on for about 1 h; natural gas |
| | consumption for breakfast is about 0.1 m³; electric |
| | kettle with 1 kW power is used to boil water for about |
| | 3 min; refrigerator continues to work |
| 7-8 | Turn off the air conditioner at home (continuous work |
| | for 13 hours); drive for half an hour to go to work; |
| | refrigerator continues to work |
| 8-9 | Take the elevator to the office on the 19th floor; turn on |
| | the office air conditioner; turn on the desktop computer; |
| | the refrigerator keeps working |
| 9-10 | The refrigerator keeps working |
| 10-11 | The refrigerator keeps working |
| 11-12 | Dispose of garbage about 1 kg; the refrigerator keeps |
| | working |
| 12-13 | Eat about 300 g of rice for lunch; about 200 g of meat; |
| | about 500 g of fruits and vegetables; the refrigerator |
| | keeps working |
| 13-14 | The refrigerator keeps working |
| 14-15 | The refrigerator keeps working |
| 15-16 | The refrigerator keeps working |
| 16-17 | Turn off the desktop computer (about 8 hours of |
| | continuous work); turn off the office air conditioner |
| | (about 8 hours of continuous work); the refrigerator |
| | keeps working |
| 17-18 | Take the elevator down 19 floors; drive home for |
| | about 0.5 h; the refrigerator keeps working |
| 18-19 | Turn on the air conditioner at home; watch TV for |
| | about 1 hour; the refrigerator keeps working |
| 20-21 | Turn on the laptop and work for 1 h; the air |
| | conditioner and the refrigerator keep working |
| 21-22 | Continue to work with the laptop for 1 h; the air |
| | conditioner and the refrigerator keep working |
| 22-23 | Take a hot bath; wash face and teeth with about 0.1 L |
| | of water; the air conditioner and the refrigerator |
| | keep working |
| 23-0 | The air conditioner and the refrigerator keep working |
| 0-1 | The air conditioner and the refrigerator keep working |
| 1-2 | The air conditioner and the refrigerator keep working |
| 2-3 | The air conditioner and the refrigerator keep working |
| 3-4 | The air conditioner and the refrigerator keep working |
| 4-5 | The air conditioner and the refrigerator keep working |
| 5-6 | Get up early to use the toilet with about 6 L water; |
| | the air conditioner and the refrigerator keep working |

2. Personal life carbon emissions estimation. Fuzzy interval processing is performed on the collected food, clothing, housing, and transportation data, and the carbon emissions corresponding to each behavior expressed by the fuzzy interval number are calculated according to the carbon emission coefficient of each behavior.

Fuzzy number is a fuzzy set on a given universe U, which means that for any x∈U, there is a number μ(x)∈[0, 1] corresponding to it, and μ(x) is called the membership degree of x to U, μ is called the membership function of x. Fuzzy numbers are usually divided into triangular fuzzy numbers and trapezoidal fuzzy numbers; taking triangular fuzzy numbers as an example, FIG. 2 shows a triangular fuzzy number \tilde{B}=(x,α,β).

Here, the meaning of (x, α, β) is that the value of the data is in the interval [x−α,x+β], and the membership function taking the value of x is expressed by the following formula:

$$μ ( x ) = \{ \begin{matrix}1 - \frac{( {x}_{0} - x )}{α} & x - α \leq x < {x}_{0} \\ 1 & x = {x}_{0} \\ 1 - \frac{( x - {x}_{0} )}{β} & {x}_{0} < x \leq {x}_{0} + β\end{matrix} ,$$

For the collected data of clothing, food, housing, transportation, “near the value x” and “approximately the value x” can be described by the triangular fuzzy interval number for fuzzy interval processing; the triangular fuzzy number can be approximated by the interval [x0−α,x0+β], here α and β can be selected according to actual behaviors of different empirical values, such as 0.5×x0 or 0.2×x0, etc.; for example, the water for washing and brushing teeth is about 0.1 L, which is represented by (0.1, 0.05, 0.05) L, where α and β is taken as 0.5×x0; driving for about 0.5 h, expressed by (0.5, 0.1, 0.1) L, where α and β are taken as 0.2×x0; for known accurate values, α and β are taken as 0, such as taking an elevator up to the 19th floor, denoted by (19, 0, 0); thus get the fuzzy interval processing results as shown in Table 3:

TABLE 3
fuzzy interval processing results of daily life
data being collected of one person in one day

| Time | |
|---|---|
| interval | Living behavior |
| 6-7 | Wash one's face and teeth with water (0.1, 0.05, 0.05) L; |
| | energy-saving lamps are turned on for (1, 0.5, 0.5) h, |
| | natural gas consumption for breakfast is (0.1, 0.05, 0.05) m³, |
| | electric kettle with 1 kW power is used to boil water for |
| | (0.05, 0.01, 0.01) h |
| 7-8 | The air conditioner at home has kept working for (13, 1, 1) h; |
| | drive a car for (0.5, 0.1, 0.1) h |
| 8-9 | Take the elevator to the office up (19, 0, 0) floors |
| 9-10 | / |
| 10-11 | / |
| 11-12 | Dispose of garbage (1, 0.5, 0.5) kg |
| 12-13 | Eat (300, 100, 100) g of rice for lunch; eat(200, 50, 50) g |
| | meat; eat (500, 100, 100) g of fruits and vegetables |
| 13-14 | / |
| 14-15 | / |
| 15-16 | / |
| 16-17 | The desktop computer has kept working for (8, 0.5, 0.5) h; |
| | the office air conditioner has kept working for(8, 0.5, 0.5) h |
| 17-18 | Take the elevator down (19, 0, 0) floors; dive a car for |
| | (0.5, 0.1, 0.1) h to go back home |
| 18-19 | Watch TV (1.0.2, 0.2) h |
| 20-21 | Turn on the laptop and work for (1, 0, 0) h |
| 21-22 | Continue to work with the laptop for (1, 0.1, 0.2) h |
| 22-23 | Take a hot bath (1, 0, 0) times, wash one's face and teeth |
| | with about (0.1, 0.05, 0.05) L of water |
| 23-5 | / |
| 5-6 | Get up early to use the toilet with about (6, 2, 2) L water |

According to the carbon emission coefficient of each behavior as shown in Table 1, the corresponding carbon emission of each behavior expressed by fuzzy interval numbers is calculated, and the calculation results are shown in Table 4:

The multiplication rule of fuzzy interval number and real number is used here: for triangular fuzzy interval number (x0,α,β) there is (x0,α,β)*λ=(x0λ,α*λ, β*λ).

TABLE 4
personal daily life carbon emission
estimation of one person in one day

| Time | |
|---|---|
| interval | Carbon emission estimation |
| 6-7 | Wash one's face and teeth: (0.1, 0.05, 0.05) L*0.194 |
| | kg/1000 L = (1.94*10⁻⁵, 9.7*10⁻⁶, 9.7*10⁻⁶) kg; turn |
| | on the energy-saving lamps: (1, 0.5, 0.5) h*0.011 kg/h = |
| | (0.011, 0.0055, 0.0055) kg; natural gas consumption for |
| | breakfast: (0.1, 0.05, 0.05) m³*2.17 kg/m³ = (0.217, |
| | 0.1085, 0.1085) kg; electric kettle with 1 kW power is |
| | used to boil water: (0.05, 0.01, 0.01) h*0.997 kg/kWh = |
| | (0.04985, 0.00997, 0.00997) kg |
| 7-8 | The air conditioner at home: 1.2 kW*(13, 1, 1) h*0.997 |
| | kg/kWh = (15.5532, 1.1964, 1.1964) kg; drive a car for |
| | work: (0.5, 0.1, 0.1) h*40 km/h*0.22 kg/km = (4.4, 0.88, |
| | 0.88) kg |
| 8-9 | Take the elevator to the office at 19^{th} floor: (19, 0, 0)*0.218 |
| | kg/floor = (4.142, 0, 0) kg |
| 9-11 | / |
| 11-12 | Dispose of garbage: (1, 0.5, 0.5) kg*2.06 kg/kg = (2.06, |
| | 1.03, 1.03) kg |
| 12-13 | Eat rice: (300, 100, 100) g/1000*0.8 kg/kg = (0.024, 0.008, |
| | 0.008); eat meat: (200, 50, 50) g/1000*1.24 kg/kg = (0.0248, |
| | 0.0062, 0.0062) kg; eat fruits and vegetables: (500, 100, 100) |
| | g/1000*0.138 kg/kg = (0.069, 0.0138, 0.0138) kg |
| 13-16 | / |
| 16-17 | The desktop computer: (8, 0.5, 0.5) h*0.013 kg/h = (0.0104, |
| | 0.0065, 0.0065) kg; the office air conditioner in office: |
| | (8, 0.5, 0.5) h*1.2 kW*0.997 kg/kWh = (9.5712, 0.5982, |
| | 0.5982) kg |
| 17-18 | Take the elevator down 19 floors: (19, 0, 0)*0.218 |
| | kg/floor = (4.142, 0, 0) kg; drive a car back home: (0.5, |
| | 0.1, 0.1) h*40 km/h*0.22 kg/km = (4.4, 0.88, 0.88) kg |
| 18-19 | Watch TV: (1, 0.2, 0.2) h*0.096 kg/h = (0.096, 0.0192, |
| | 0.0192) kg |
| 20-21 | Use the laptop: (1, 0, 0) h*0.013 kg/h = (0.013, 0, 0) kg |
| 21-22 | Use the laptop: (1, 0.1, 0.2) h*0.013 kg/h = (0.013, 0.0013, |
| | 0.0026) kg |
| 22-23 | Take a hot bath: (1, 0, 0) time*0.42 kg/time = (0.42, 0, 0); |
| | wash one's face and teeth: (0.1, 0.05, 0.05) L*0.194 |
| | kg/1000 L = (1.94*10⁻⁵, 9.7*10⁻⁶, 9.7*10⁻⁶) kg |
| 23-5 | / |
| 5-6 | Get up early to use the toilet: (6, 2, 2) L*0.194 kg/1000 L = |
| | (1.164, 0.388, 0.388) kg |

3. Using fuzzy interval number addition, add the carbon emissions corresponding to each behavior of a person in a day to get the total carbon emissions of the day.

The addition rule of fuzzy interval numbers is used here:

For two triangular fuzzy interval numbers \tilde{X}₁=(x1,α1,β1) and \tilde{X}₂=(x2,α2,β2),

\tilde{X}₁+\tilde{X}₂=(x1+x2, α1+α2, β1+β2),

In this numerical example, the result of adding up the carbon emissions corresponding to each behavior of a person in a day in Table 4 is approximately (46.38, 5.15, 5.15) kg.

Add a person's daily carbon emissions in a week to get the fuzzy interval value of their total weekly carbon emissions; and add a person's daily carbon emissions in a month to get the fuzzy interval value of their monthly carbon emissions. According to the above steps, get the fuzzy interval value of daily, weekly, and annual carbon emissions of each person in the community as the number of intervals to be compared, and divide by the number of people to be compared in the community to obtain the fuzzy average carbon emission, (xm,αm,βm), and then get the reference interval number [xm−αm, xm+βm]. Assuming that the fuzzy carbon emissions of three persons A, B, and C on a certain day are (46.38, 5.15, 5.15) kg, (44.02, 4.95, 4.95) kg and (44.60, 4.90, 4.90) kg, respectively, then the three persons' mean value of fuzzy carbon emission is (45.0, 5.0, 5.0) kg, so the interval [40.0, 50.0] kg is taken as the reference interval number \hat{X}₀, Mid(\hat{X}₀)=45.0 kg, r0=Rad(\hat{X}₀)=5.0 kg. Use the fuzzy interval size comparison method, the carbon emission intervals corresponding to A, B, and C are respectively =[41.23,51.53] kg, =[39.07,48.97] kg, =[39.70,49.50] kg, and the midpoint and radius are Mid(\hat{X}_{A})=46.38 kg, Rad(\hat{X}_{A})=5.15 kg, Mid(\hat{X}_{B})=44.02 kg, Rad(\hat{X}_{B})=4.95 kg, Mid(\hat{X}_{C})=44.6 kg, Rad(\hat{X}_{C})=4.90 kg, respectively, and then get

dA=Mid(\hat{X}₀)−Mid(\hat{X}_{A})=45.0−46.38=−1.38 (kg),

dB=Mid(\hat{X}₀)−Mid(\hat{X}_{B})=45.0−44.02=0.98 (kg),

dC=Mid(\hat{X}₀)−Mid(\hat{X}_{C})=45.0−44.60=0.40 (kg),

Substitute the credibility measurement expression:

$$ρ ( {d}_{i} ) = \{ \begin{matrix}\frac{{d}_{i} + {r}_{0} + {r}_{i}}{{r}_{0}} & {d}_{i} < - ( {r}_{0} + {r}_{i} ) \\ \frac{1}{2} {( \frac{{d}_{i} + {r}_{0} + {r}_{i}}{{r}_{0} + {r}_{i}} )}^{2} & - ( {r}_{0} + {r}_{i} ) \leq {d}_{i} < 0 \\ 0.5 & {d}_{i} = 0 \\ 1 - \frac{1}{2} {( \frac{{r}_{0} + {r}_{i} - {d}_{i}}{{r}_{0} + {r}_{i}} )}^{2} & 0 < {d}_{i} \leq {r}_{0} + {r}_{i} \\ \frac{{d}_{i}}{{r}_{0}} & {d}_{i} > {r}_{0} + {r}_{i}\end{matrix} ,$$

Obtain the confidence degree that the carbon emission intervals corresponding to the three persons A, B, and C are less than the reference carbon emission interval number: ρ(dA)≈0.373, ρ(dB)≈0.594, ρ(dC)≈0.540.

It can be seen that ρ(dB)>ρ(dC)>ρ(dA), from which the daily carbon emissions of A, B, and C are ranked from small to large, so that it is concluded that among the three persons, B's lifestyle is lower carbon.

In the same way, compare an individual's carbon emissions in a week or a month with a weekly or monthly benchmark interval number. According to the comparison results, the individual's weekly or monthly carbon emissions can be ranked from small to large.

This invention uses the living carbon emission data information of 120 volunteers in a community to carry out an example analysis, and the estimated result is consistent with the actual situation. The result of carbon emission ranking by this method effectively considers the uncertainty, and the practice proves that the estimation and the ranking result is recognized by people, and it has a good role in guiding people to analyze personal carbon emission behavior and develop low-carbon and environmentally friendly living habits.

Finally, it should be pointed out that the above embodiments are only used to illustrate the technical solutions of the present invention, but not to limit them. Although this invention has been described in detail with reference to the foregoing embodiments, those of ordinary skill in the art should understand that they can still modify the technical solutions described in the foregoing embodiments, or equivalently replace some of the technical features; and these modification or replacement does not cause the essence of the corresponding technical solutions to deviate from the spirit and scope of the technical solutions of the embodiments of this invention.

1. An estimation and ranking method for carbon emission of individual life, the steps are as follows:
1) collecting and acquiring personal daily life food, clothing, housing and transportation data;
2) fuzzy interval processing is performed on the collected food, clothing, housing and transportation data, and the carbon emission corresponding to each behavior expressed by the fuzzy interval number is calculated according to the carbon emission coefficient of each behavior;
3) adopting fuzzy interval number addition rule, add the carbon emissions corresponding to each individual behavior to obtain the fuzzy interval value of the total carbon emissions of the individual on different time scales, then use the same method to obtain the fuzzy interval value of total carbon emissions of each person in the specific group on different time scales;
4) sum the fuzzy interval values of the total carbon emissions of each person in a specific group on the same time scale, and divide by the total number of people in the specific group to obtain the per capita fuzzy carbon emission value, and then obtain the benchmark interval number, then using the fuzzy interval number comparison method, the ranking of the carbon emissions of individuals in a specific group on the same time scale is obtained.

2. The estimation and ranking method for carbon emission of individual life according to claim 1, wherein the fuzzy interval processing method for the collected food, clothing, housing and transportation data is: processing the food, clothing, housing and transportation data x to obtain a triangular fuzzy number \tilde{B}=(x,α,β), where (x,α,β)means that the value of the data x is in the interval [x−α,x+β].

3. The estimation and ranking method for carbon emission of individual life according to claim 2, wherein the ranking method of fuzzy interval number is:
getting the reference interval number \hat{X}₀=[x, x̅], and the midpoint of the interval is Mid(\hat{X}₀)=(x̅+x)/2, the radius of the interval r0=(x̅−x)/2, then for the multiple fuzzy interval values (i=1, 2, . . . , m) to be compared for a specific group, obtaining the midpoint of the intervals Mid(\hat{X}ᵢ) and the radius ri=Rad(\hat{X}ᵢ), and obtaining di=Mid(\hat{X}₀)−Mid(\hat{X}ᵢ), and using the following formula to obtain a credibility measure ρ(dᵢ) for which the fuzzy interval value of individual carbon emission to be compared is less than the reference interval number, wherein the greater the credibility measure, the less the individual's carbon emission:
$$ρ ( {d}_{i} ) = \{ \begin{matrix}\frac{{d}_{i} + {r}_{0} + {r}_{i}}{{r}_{0}} & {d}_{i} < - ( {r}_{0} + {r}_{i} ) \\ \frac{1}{2} {( \frac{{d}_{i} + {r}_{0} + {r}_{i}}{{r}_{0} + {r}_{i}} )}^{2} & - ( {r}_{0} + {r}_{i} ) \leq {d}_{i} < 0 \\ 0.5 & {d}_{i} = 0 \\ 1 - \frac{1}{2} {( \frac{{r}_{0} + {r}_{i} - {d}_{i}}{{r}_{0} + {r}_{i}} )}^{2} & 0 < {d}_{i} \leq {r}_{0} + {r}_{i} \\ \frac{{d}_{i}}{{r}_{0}} & {d}_{i} > {r}_{0} + {r}_{i}\end{matrix} .$$

4. The estimation and ranking method for carbon emission of individual life according to claim 1, wherein the personal daily life of the individual's daily life includes: occurrence period, behavioral type, specific behavior, duration, and quantity.
